(19) United States
(12) Patent Application Publication
(10) Pub. No.: US 2025/0260456 A1
(43) Pub. Date: Aug. 14, 2025

(54) METHOD AND APPARATUS FOR TRANSMITTING INFORMATION, METHOD AND APPARATUS FOR PROCESSING INFORMATION, AND COMMUNICATION DEVICE

(71) Applicant: VIVO MOBILE COMMUNICATION CO., LTD., Guangdong (CN)

(72) Inventors: Qianyao REN, Guangdong (CN); Hao WU, Guangdong (CN)

(73) Assignee: VIVO MOBILE COMMUNICATION CO., LTD., Guangdong (CN)

(21) Appl. No.: 19/190,143

(22) Filed: Apr. 25, 2025

Related U.S. Application Data
(63) Continuation of application No. PCT/CN2023/125561, filed on Oct. 20, 2023.

(30) Foreign Application Priority Data
Oct. 27, 2022 (CN) 202211329924.7

(51) Int. Cl. H04B 7/06; H04L 5/00; H04L 41/16

(52) U.S. Cl. CPC H04B 7/0626; H04B 7/0639; H04L 5/0005; H04L 41/16

(57) ABSTRACT

A method and apparatus for transmitting information, a method and apparatus for processing information, and a communication device. The method for transmitting information according to embodiments of the disclosure includes: determining, by a terminal, K groups of second channel information from first channel information based on first information; performing, by the terminal based on first AI network models corresponding to M groups of second channel information respectively, first processing on the M groups of second channel information, and obtaining M pieces of channel feature information, where the K groups of second channel information includes the M groups of second channel information; and transmitting, by the terminal, second information to a network side device, where the second information includes the M pieces of channel feature information.

### CROSS-REFERENCE TO RELATED APPLICATIONS

The application is a continuation of International Application No. PCT/CN2023/125561 filed on Oct. 20, 2023, which claims the priority of Chinese Patent Application No. 202211329924.7 filed on Oct. 27, 2022, which are incorporated herein by reference in their entireties.

### TECHNICAL FIELD

The disclosure belongs to the technical field of communication, and particularly relates to a method and apparatus for transmitting information, a method and apparatus for processing information, and a communication device.

### BACKGROUND

The research on a method for transmitting channel feature information in virtue of an artificial intelligence (AI) network model has been carried out in the related art.

The AI network model can include an encoding section (i.e. an encoding AI network model) and a decoding section (i.e. a decoding AI network model). The encoding AI network model is configured to encode channel information into the channel feature information. The decoding AI network model is configured to restore the channel feature information output by the encoding AI network model into the channel information.

In the related art, an AI network model has a fixed input dimension. Thus, different AI network models are required for channel information having different numbers of channel state information-reference signal (CSI-RS) ports. For example: since an AI network model trained with 8 CSI-RS ports is unusable in a channel having 16 CSI-RS ports, AI network models matching different numbers of CSI-RS ports need to be trained and transferred. In this way, the calculation amount for training the AI network models matching different numbers of CSI-RS ports will be increased, and overheads for transmitting the AI network models matching different numbers of CSI-RS ports will be increased.

### SUMMARY

In a first aspect, a method for transmitting information is provided. The method includes:
determining, by a terminal, K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1;
performing, by the terminal based on first AI network models corresponding to M groups of second channel information respectively, first processing on the M groups of second channel information, and obtaining M pieces of channel feature information, where the K groups of second channel information includes the M groups of second channel information; and
transmitting, by the terminal, second information to a network side device, where the second information includes the M pieces of channel feature information.

In a second aspect, an apparatus for transmitting information is provided. The apparatus is applied to a terminal and includes:
a first determination module configured to determine K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1;
a first processing module configured to perform, based on first AI network models corresponding to M groups of second channel information respectively, first processing on the M groups of second channel information, and obtain M pieces of channel feature information, where the K groups of second channel information includes the M groups of second channel information; and
a first transmission module configured to transmit second information to a network side device, where the second information includes the M pieces of channel feature information.

In a third aspect, a method for processing information is provided. The method includes:
receiving, by a network side device, second information from a terminal, where the second information includes M pieces of channel feature information, and the M pieces of channel feature information is channel feature information obtained by performing, based on first AI network models corresponding to M groups of second channel information respectively, first processing on the M groups of second channel information;
determining, by the network side device, second AI network models corresponding to the M pieces of channel feature information based on first information respectively, where the first information includes grouping information of K groups of channel state information-reference signal (CSI-RS) transmission ports, K groups of second channel information corresponds one-to-one to the K groups of CSI-RS transmission ports, each of the K groups of CSI-RS transmission ports includes at least one CSI-RS transmission port, the K groups of second channel information includes the M groups of second channel information, and K and M are integers greater than or equal to 1; and
performing, by the network side device, second processing on the M pieces of channel feature information based on the second AI network models corresponding to the M pieces of channel feature information respectively, and obtaining the M groups of second channel information.

In a fourth aspect, an apparatus for processing information is provided. The apparatus is applied to a network side device and includes:
a first reception module configured to receive second information from a terminal, where the second information includes M pieces of channel feature information, and the M pieces of channel feature information is channel feature information obtained by performing, based on first AI network models corresponding to M groups of second channel information respectively, first processing on the M groups of second channel information;
a second determination module configured to determine second AI network models corresponding to the M pieces of channel feature information based on first information respectively, where the first information includes grouping information of K groups of channel state information-reference signal (CSI-RS) transmission ports, K groups of second channel information corresponds one-to-one to the K groups of CSI-RS transmission ports, each of the K groups of CSI-RS transmission ports includes at least one CSI-RS transmission port, the K groups of second channel information includes the M groups of second channel information, and K and M are integers greater than or equal to 1; and
a second processing module configured to perform second processing on the M pieces of channel feature information based on the second AI network models corresponding to the M pieces of channel feature information respectively, and obtain the M groups of second channel information.

In a fifth aspect, a communication device is provided. The communication device includes a processor and a memory, where the memory stores a program or instruction runnable on the processor, and the program or instruction, when executed by the processor, implements steps of the method in the first aspect or the third aspect.

In a sixth aspect, a terminal is provided. The terminal includes a processor and a communication interface; where the processor is configured to determine K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1; the processor is further configured to perform, based on first AI network models corresponding to M groups of second channel information respectively, first processing on the M groups of second channel information, and obtain M pieces of channel feature information, where the K groups of second channel information includes the M groups of second channel information; and the communication interface is configured to transmit second information to a network side device, where the second information includes the M pieces of channel feature information.

In a seventh aspect, a network side device is provided. The network side device includes a processor and a communication interface; where the communication interface is configured to receive second information from a terminal, where the second information includes M pieces of channel feature information, and the M pieces of channel feature information is channel feature information obtained by performing, based on first AI network models corresponding to M groups of second channel information respectively, first processing on the M groups of second channel information; the processor is configured to determine second AI network models corresponding to the M pieces of channel feature information based on first information respectively, where the first information includes grouping information of K groups of channel state information-reference signal (CSI-RS) transmission ports, K groups of second channel information corresponds one-to-one to the K groups of CSI-RS transmission ports, each of the K groups of CSI-RS transmission ports includes at least one CSI-RS transmission port, the K groups of second channel information includes the M groups of second channel information, and K and M are integers greater than or equal to 1; and the processor is further configured to perform second processing on the M pieces of channel feature information based on the second AI network models corresponding to the M pieces of channel feature information respectively, and obtain the M groups of second channel information.

In an eighth aspect, a communication system is provided. The communication system includes: a terminal and a network side device, where the terminal is capable of being configured to execute steps of the method for transmitting information in the first aspect, and the network side device is capable of being configured to execute steps of the method for processing information in the third aspect.

In a ninth aspect, a readable storage medium is provided. The readable storage medium stores a program or instruction, where the program or instruction, when executed by a processor, implements steps of the method for transmitting information in the first aspect, or steps of the method for processing information in the third aspect.

In a tenth aspect, a chip is provided. The chip includes a processor and a communication interface, where the communication interface is coupled to the processor, and the processor is configured to run a program or instruction, so as to implement the method for transmitting information in the first aspect or the method for processing information in the third aspect.

In an eleventh aspect, a computer program/program product is provided. The computer program/program product is stored in a storage medium, and the computer program/program product is executed by at least one processor, so as to implement steps of the method for transmitting information in the first aspect, or steps of the method for processing information in the third aspect.

### BRIEF DESCRIPTION OF THE DRAWINGS

FIG. 1 is a schematic structural diagram of a radio communication system to which embodiments of the disclosure can be applied;

FIG. 2 is a flowchart of a method for transmitting information according to an embodiment of the disclosure;

FIG. 3 is a flowchart of a method for processing information according to an embodiment of the disclosure;

FIG. 4 is a schematic structural diagram of an apparatus for transmitting information according to an embodiment of the disclosure;

FIG. 5 is a schematic structural diagram of an apparatus for processing information according to an embodiment of the disclosure;

FIG. 6 is a schematic structural diagram of a communication device according to an embodiment of the disclosure;

FIG. 7 is a schematic structural diagram of hardware of a terminal according to an embodiment of the disclosure; and

FIG. 8 is a schematic structural diagram of a network side device according to an embodiment of the disclosure.

### DETAILED DESCRIPTION

The technical solutions in embodiments of the disclosure are clearly described below with reference to the accompanying drawings in the embodiments of the disclosure. Apparently, the embodiments described are some embodiments rather than all embodiments of the disclosure. Based on the embodiments of the disclosure, all other embodiments derived by those of ordinary skill in the art should fall within the scope of protection of the disclosure.

In the specification and claims of the disclosure, the terms such as “first” and “second” are intended to distinguish between similar objects, but are not used to indicate a specific order or successive sequence. It should be understood that the terms used in this way can be interchanged under appropriate circumstances, so that the embodiments of the disclosure can be implemented in an order except for those illustrated or described herein. In addition, the objects distinguished by “first” and “second” are usually objects of one type, and a number of objects is unlimited. For example, a first object can indicate one or more first objects. In addition, “and/or” in the specification and claims indicates at least one of objects connected. The character “/” generally indicates that objects associated are in an “or” relationship.

It should be noted that the technology described in the embodiments of the disclosure is not limited to a long term evolution (LTE)/LTE-advanced (LTE-A) system, and can also be used in other radio communication systems, such as code division multiple access (CDMA), time division multiple access (TDMA), frequency division multiple access (FDMA), orthogonal frequency division multiple access (OFDMA), and single-carrier frequency division multiple access (SC-FDMA). The terms “system” and “network” in the embodiments of the disclosure are often used interchangeably, and the technology described can be used for the systems and radio technologies mentioned above, as well as other systems and radio technologies. The following descriptions illustratively describe a new radio (NR) system, and the NR terms are used in most of the following descriptions. However, these technologies can also be applied to applications except for an application in the NR system, such as a 6th generation (6G) communication system.

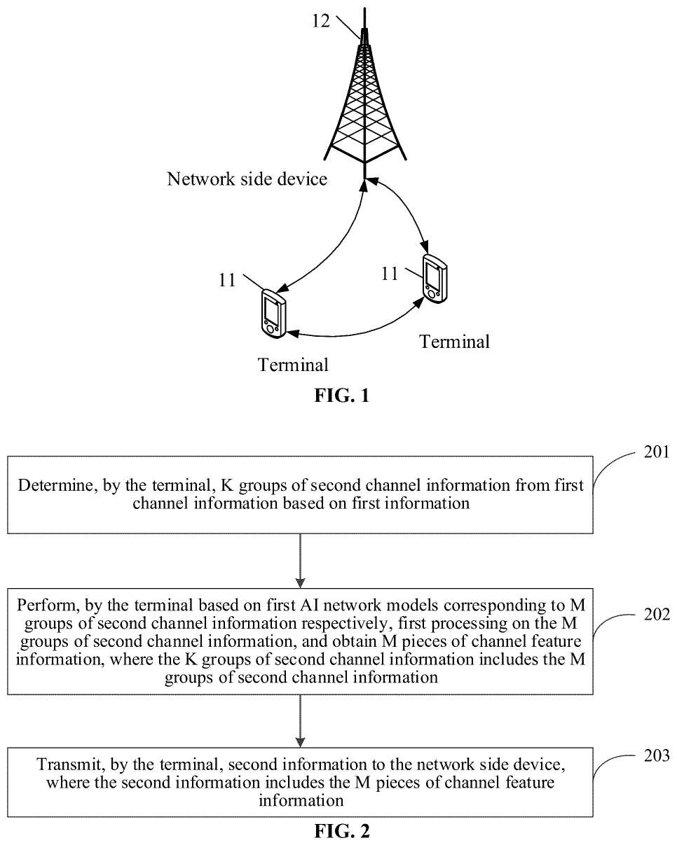

FIG. 1 is a block diagram of a radio communication system to which the embodiments of the disclosure can be applied. The radio communication system includes a terminal 11 and a network side device 12. The terminal 11 can be a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home appliance (a home device with a radio communication function, such as a refrigerator, a television, a washing machine, and furniture), and a terminal side device such as a game console, a personal computer (PC), an automated teller machine, and a self-service machine. The wearable device includes: a smartwatch, a smart band, a smart headset, smart glasses, smart jewelry (a smart bracelet, a smart chain bracelet, a smart ring, a smart necklace, a smart anklet, a smart ankle chain, etc.), a smart wrist strap, a smart garment, etc. It should be noted that a specific type of the terminal 11 is not limited in the embodiments of the disclosure. The network side device 12 can include an access network device or core network device. The access network device can also be referred to as a radio access network device, a radio access network (RAN), a radio access network function, or a radio access network unit. The access network device can include a base station, a wireless local area network (WLAN) access point, a WiFi node, etc. The base station can be referred to as a node B, an evolved node B (eNB), an access point, a base transceiver station (BTS), a radio base station, a radio transceiver, a basic service set (BSS), an extended service set (ESS), a home node B, a home evolved node B, a transmitting receiving point (TRP), or some other suitable terms in the art. As long as the same technical effect is achieved, the base station is not limited to a specific technical term. It should be noted that in the embodiments of the disclosure, only the base station in the NR system is described as an example, and a specific type of the base station is not limited.

According to the information theory, accurate channel state information (CSI) is crucial to a channel capacity. Especially for a multi-antenna system, a transmission end can optimize signal transmission based on the CSI for a better match with a state of a channel. For example: a channel quality indicator (CQI) can be used for selecting a suitable modulation and coding scheme (MCS) to achieve link adaptation; and a precoding matrix indicator (PMI) can be used for implementing eigen beamforming to maximize strength of a received signal, or suppress interference (for example, interference between cells or interference between a plurality of users). Thus, CSI acquisition has been a research hotspot since a multiple-input multiple-output (MIMO) technology is proposed.

Generally, the base station transmits a CSI reference signal (CSI-RS) on some time-frequency resources of a slot. The terminal performs channel estimation based on the CSI-RS, calculates channel information on this slot, and feeds back a PMI to the base station through a codebook. The base station obtains the channel information through combination based on codebook information fed back by the terminal. Before CSI is reported next time, the base station performs data precoding and multi-user scheduling based on the channel information.

To further reduce CSI feedback overheads, the terminal can change PMI reporting on each sub-band to PMI reporting according to a delay. Since channels in a delay domain are more concentrated, PMIs on all sub-bands can be approximately represented by PMIs with fewer delays. In other words, delay-domain information is compressed before reported.

Similarly, to reduce overheads, the base station can precode the CSI-RS, and transmit an encoded CSI-RS to the terminal. The terminal acquires a channel corresponding to the encoded CSI-RS. The terminal only needs to select several ports having high strength from ports indicated by a network side, and report coefficients corresponding to the ports.

Further, a neural network or machine learning method can be used for better compressing the channel information.

At present, artificial intelligence is widely applied to various fields. An AI module is implemented in various forms, for example, a neural network, a decision tree, a support vector machine, and a Bayes classifier. In the disclosure, the neural network is described as an example, but a specific type of the AI module is not limited.

Parameters of the neural network are optimized through an optimization algorithm. The optimization algorithm is a type of algorithm that is conducive to minimization or maximization of an objective function (sometimes referred to as a loss function). The objective function is usually a mathematical combination of a model parameter and data. For example, assuming that data x and a label Y corresponding to the data are given, one neural network model f (.) is constructed. With the model, a predicted output f(x) can be obtained based on an input x, and a difference (f(x)-Y) between a predicted value and a real value can be calculated. To find an appropriate weight and bias, a value of the above loss function reaches a minimum. A smaller loss value indicates that the model is closer to a real situation.

Currently, common optimization algorithms are basically based on an error back propagation (BP) algorithm. A basic idea of the BP algorithm is that a learning process includes signal forward propagation and error back propagation. During the forward propagation, an input sample is transmitted from an input layer, processed layer by layer by each hidden layer, and then transmitted to an output layer. If an actual output of the output layer does not match an expected output, an error back propagation stage is entered. The error back propagation is to propagate an output error layer by layer back to the input layer through the hidden layers in a particular form, and assign the error to all units of each layer, so as to obtain an error signal of the units of each layer. The error signal is used as a basis for correcting a weight of each unit. Such a weight adjustment process for each layer based on the signal forward propagation and error back propagation is performed cyclically. The process of continuously adjusting the weight is a learning and training process of the network. The process continues being performed until an error output by the network is reduced to an acceptable degree or a preset number of learning is performed.

The common optimization algorithms include gradient descent, stochastic gradient descent (SGD), mini-batch gradient descent, momentum, stochastic gradient descent with momentum (Nesterov), adaptive gradient descent (Adagrad), adaptive learning rate adjustment (Adadelta), root mean square prop (RMSprop), adaptive moment estimation (Adam), etc.

During error back propagation, in these optimization algorithms, an error/loss is obtained based on the loss function, a gradient is obtained by calculating a derivative/partial derivative of a current neuron, and adding an effect such as a learning rate and a previous gradient/derivative/partial derivative, and the gradient is transferred to an upper layer.

A CSI compression recovery flow is as follows: The terminal estimates a CSI-RS, calculates channel information, inputs the channel information calculated or channel information originally estimated into the encoding AI network model, so as to obtain an encoded result, and transmits the encoded result to the base station. The base station receives the encoded result, and inputs the encoded result into the decoding AI network model to restore the channel information.

Specifically, a CSI compression feedback solution based on the neural network is as follows: the terminal compresses and encodes the channel information, and transmits a compressed content to the base station. The base station decodes the compressed content to restore the channel information. In this case, the decoding AI network model of the base station and the encoding AI network model of the terminal need to be jointly trained to achieve a proper match degree. The channel information serves as an input of the encoding AI network model, and encoded information, i.e. channel feature information serves as an output thereof. The encoded information serves as an input of the decoding AI network model, and the channel information recovered serves as an output thereof.

Generally, the channel information input to the encoding AI network model is a channel matrix or precoding matrix of each sub-band. With the precoding matrix as an example, a number of columns of the precoding matrix equals a number of ranks, i.e. a total number of layers, and a number of rows of the precoding matrix equals a number of CSI-RS ports. In this way, an input dimension of the encoding AI network model is determined by the number of ranks, the number of CSI-RS ports, and the number of sub-bands jointly. In the related art, channel information of each channel is processed by one encoding AI network model. When a number of CSI-RS ports of the channel is changed, the channel information of the channel no longer matches the encoding AI network model that is used before the number of the CSI-RS ports is changed. In this case, a new encoding AI network model and a new decoding AI network model need to be retrained. In this way, to adapt to various number of antenna ports and various antenna port structures, a variety of AI network models need to be pretrained, increasing complexity of training the AI network models, adding overheads for transmitting the AI network models, increasing complexity of matching the encoding AI network model with the decoding AI network model, and prolonging time of matching the encoding AI network model with the decoding AI network model.

In the embodiments of the disclosure, CSI-RS transmission ports are grouped, and channel information corresponding to at least one CSI-RS transmission port located in one group is processed by one AI network model. In this way, an AI network model having a smaller number of CSI-RS transmission ports can process channel information having a greater number of CSI-RS transmission ports, so that the number of AI network models is decreased, and a size of the AI network model is reduced.

For example: 32 CSI-RS transmission ports configured for one channel are divided into 4 groups, 8 CSI-RS transmission ports are located in each group, and one AI network model needs to process only channel information of the 8 CSI-RS transmission ports. When a number of the CSI-RS transmission ports of the channel is changed to 16, the CSI-RS transmission ports are divided into 2 groups, and 8 CSI-RS transmission ports are located in each group. In this case, channel information of the 2 groups of CSI-RS transmission ports can be processed by multiplexing a same AI network model.

A method and apparatus for transmitting information, a method and apparatus for processing information, and a communication device according to the embodiments of the disclosure will be described in detail below with some embodiments and their application scenarios in conjunction with the accompanying drawings.

With reference to FIG. 2, a method for transmitting information according to the embodiments of the disclosure is shown. An execution subject for the method is a terminal. As shown in FIG. 2, the method for transmitting information executed by the terminal may include:

Step 201, the terminal determines K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1.

The first channel information may be an original channel matrix or precoding matrix of a channel, or a preprocessed channel matrix or precoding matrix. For ease of description, in the embodiments of the disclosure, the channel information being the precoding matrix is usually illustratively described as an example, but is not intended for specific limitation.

Optionally, one group of second channel information includes at least one of the following:
an original channel matrix corresponding to one group of CSI-RS transmission ports, where the one group of CSI-RS transmission ports correspond to the one group of second channel information;
a matrix, formed by elements corresponding to the one group of CSI-RS transmission ports, in a first precoding matrix, where the first precoding matrix is a precoding matrix of the first channel information; and
a second precoding matrix, where the second precoding matrix is a precoding matrix of the one group of second channel information.

The first precoding matrix may be a precoding matrix determined with the first channel information as a whole. The second precoding matrix may be a precoding matrix determined with one group of second channel information as a whole.

In an implementation, any two of the K groups of second channel information may partially overlap. For example: assuming that a target channel includes 32 CSI-RS transmission ports, and K equals 3, a first group of second channel information includes the 0th to 11th CSI-RS transmission ports, a second group of second channel information includes the 12th to 21st CSI-RS transmission ports, and a third group of second channel information includes the 20th to 31st CSI-RS transmission ports.

In an implementation, any two of the K groups of second channel information do not overlap.

In an implementation, the K groups of second channel information has a same length.

In an implementation, the K groups of second channel information may have different lengths. For example: assuming that K equals 2, one group of second channel information includes channel information of 4 CSI-RS transmission ports, and another group of second channel information includes channel information of 8 CSI-RS transmission ports.

Step 202, the terminal performs, based on first AI network models corresponding to M groups of second channel information respectively, first processing on the M groups of second channel information, and obtains M pieces of channel feature information, where the K groups of second channel information includes the M groups of second channel information.

The first AI network model may be the encoding AI network model. The first processing may include: at least one of encoding, compression, quantization, etc.

In an implementation, the M groups of second channel information may correspond to a same first AI network model. In this case, the M groups of second channel information has a same length or not. Second channel information having different lengths may be adjusted to channel information having a consistent length by means of zero-filling. Adjusted channel information having the consistent length is processed by the same first AI network model.

In an implementation, the first AI network models corresponding to the M groups of second channel information respectively are different from one another.

In an implementation, some of the M groups of second channel information corresponds to a same first AI network model, and the others of the M groups of second channel information corresponds to first AI network models different from one another.

Step 203, the terminal transmits second information to a network side device, where the second information includes the M pieces of channel feature information.

In an implementation, the terminal reports the M pieces of channel feature information through a CSI report.

During implementation, when receiving the M pieces of channel feature information, the network side device performs second processing on the M pieces of channel feature information based on second AI network models corresponding to the M pieces of channel feature information respectively, so as to restore the M groups of second channel information. The second processing may be at least one of decoding, decompression, dequantization, etc.

As an optional implementation, the first information includes at least one of the following:
a value of K;
a number of CSI-RS transmission ports in each group of CSI-RS transmission ports; and
identifiers of the CSI-RS transmission ports in each group of CSI-RS transmission ports.

Option 1, the value of K is used for indicating a number of groups into which all CSI-RS transmission ports of the target channel are divided.

In an implementation, the terminal may evenly divide all the CSI-RS transmission ports of the target channel into K groups. For example: assuming that the target channel includes X CSI-RS transmission ports, and the value of K is indicated by the base station or agreed on by a protocol, the terminal determines that each group of CSI-RS transmission ports include X÷K CSI-RS transmission ports.

It should be noted that during implementation, in a case that X cannot be evenly divided by K, a processing method for the case without even division may be agreed on by the protocol, indicated by the base station, or determined and reported by the terminal. For example: assuming that X equals 16, and K equals 5, the terminal may divide the X CSI-RS transmission ports into 5 groups, each group includes 3 CSI-RS transmission ports, and the remaining 1 CSI-RS transmission port may not be reported.

In an implementation, the terminal may divide all the CSI-RS transmission ports of the target channel into K groups having no completely-identical length.

Option 2: the number of CSI-RS transmission ports in each group of CSI-RS transmission ports may be as follows: the first group of CSI-RS transmission ports include A1 CSI-RS transmission ports, the second group of CSI-RS transmission ports include A2 CSI-RS transmission ports . . . , and a Kth group of CSI-RS transmission ports include Ak CSI-RS transmission ports. In this way, the terminal may determine the number of CSI-RS transmission ports encompassed in each of the K groups of CSI-RS transmission ports on this basis.

In an implementation, the CSI-RS transmission ports in one group of CSI-RS transmission ports may be CSI-RS transmission ports continuously arranged.

Option 3, the identifiers of the CSI-RS transmission ports in each group of CSI-RS transmission ports may be as follows: which the CSI-RS transmission port or CSI-RS transmission ports are specifically encompassed in each group of CSI-RS transmission ports is determined. The identifier of the CSI-RS transmission port may be a figure, for example, an arrangement order of the CSI-RS transmission ports. For example: the first group of CSI-RS transmission ports include CSI-RS transmission ports 1, 3, and 5; and the second group of CSI-RS transmission ports include CSI-RS transmission ports 2, 4, and 6.

In an implementation, the CSI-RS transmission ports in one group of CSI-RS transmission ports may be CSI-RS transmission ports discontinuously arranged.

As an optional implementation, the first information satisfies at least one of the following:
indicated by the network side device;
selected by the terminal; and
agreed on by the protocol.

In an implementation, the network side device may indicate the grouping information of the CSI-RS transmission ports through signaling. For example: a number K for grouping, the number of CSI-RS transmission ports in each group of CSI-RS transmission ports is included, or which CSI-RS transmission port or CSI-RS transmission ports are specifically included in each group of CSI-RS transmission ports is included.

In an implementation, the network side device may configure the grouping information of the CSI-RS transmission ports in a CSI report configuration (report config).

In an implementation, the terminal may determine a port grouping method based on an input dimension of the first AI network model possessed by the terminal. Thus, each group of second channel information obtained after grouping matches the input dimension of the first AI network model possessed by the terminal.

During implementation, if selecting or determining the first information, the terminal may report the first information to the network side device.

In an implementation, the grouping information of the CSI-RS transmission ports may be agreed on by the protocol.

For example: the protocol agrees that CSI-RS transmission ports located in a same group satisfy at least one of the following:
polarization directions are the same. In other words, for the CSI-RS transmission ports, CSI-RS transmission ports in a first quantization direction are divided into one group, and CSI-RS transmission ports in a second quantization direction are divided into another group. For example: the first polarization direction is a horizontal polarization direction, and the second polarization direction is a vertical polarization direction; or the first polarization direction is a +45 degree polarization direction, and the second polarization direction is a −45 degree polarization direction, which is not exhaustively listed herein.

Corresponding transmission antennas are located in a same row. In other words, transmission antennas corresponding to the CSI-RS transmission ports in one group are located in a same row on an antenna panel of the network side device.

Corresponding transmission antennas are located in a same column. In other words, transmission antennas corresponding to the CSI-RS transmission ports in one group are located in a same column on the antenna panel of the network side device.

Time-domain resources are the same.

Frequency-domain resources are the same.

Code division multiple (CDMA) manners are the same.

N CSI-RS transmission ports continuously arranged in all CSI-RS transmission ports for the first channel information are included, where N is an integer greater than or equal to 1.

In an implementation, one group of CSI-RS transmission ports include CSI-RS transmission ports of different CDMs corresponding to a same time-frequency resource. Or one group of CSI-RS transmission ports include CSI-RS transmission ports on all time-frequency resources corresponding to a same CDM.

In an implementation, in a case that the CSI-RS transmission ports located in the same group are N CSI-RS transmission ports continuously arranged, the CSI-RS transmission ports in the first group of CSI-RS transmission ports and the CSI-RS transmission ports in the second group of CSI-RS transmission ports may be arranged sequentially or reversely. The first group of CSI-RS transmission ports and the second group of CSI-RS transmission ports are two adjacent groups of CSI-RS transmission ports in the K groups of CSI-RS transmission ports. For example: the first group of CSI-RS transmission ports include the 0th to 9th CSI-RS transmission ports, and the second group of CSI-RS transmission ports include the 10th to 16th CSI-RS transmission ports.

Optionally, a value of N may be agreed on by the protocol, indicated by the network side device, or determined based on the value of K and a total number of CSI-RS transmission ports of the target channel. For example: assuming that the target channel includes X CSI-RS transmission ports, N=X÷K.

In an implementation, the network side device may indicate the value of K, the protocol may agree that the CSI-RS transmission ports located in the same group have the same polarization direction, and the terminal may determine the number of CSI-RS transmission ports encompassed in each group of CSI-RS, and determine which CSI-RS transmission port or CSI-RS transmission ports are specifically encompassed according to K indicated by the network side device and the agreement by the protocol that the CSI-RS transmission ports located in the same group have the same polarization direction.

As an optional implementation, the method for transmitting information further includes:
the terminal determines the first information based on the first AI network model possessed; and
the terminal transmits first indication information to the network side device, where the first indication information indicates the first information.

During implementation, after determining the first information, the terminal reports the first information to the network side device. In this way, the network side device may determine, based on the first information received, channel information that is of the CSI-RS transmission ports and based on which each piece of channel feature information is determined, so as to restore the channel information of the CSI-RS transmission ports.

In the implementation, the terminal may determine the first information based on the input dimension of the first AI network model possessed, so that a dimension of each group of second channel information divided according to the first information matches the input dimension of the first AI network model.

As an optional implementation, before the step that the terminal determines K groups of second channel information from first channel information based on first information, the method for transmitting information further includes:
the terminal receives third information from the network side device.

The third information indicates or configures the first information; or the third information indicates a first identifier, the first identifier is associated with the first information, and the terminal acquires a first association relationship between the first information and the first identifier.

In an implementation, the expression that the terminal acquires a first association relationship between the first information and the first identifier may indicate that association relationships between various first information and first identifiers thereof are agreed on by the protocol or preconfigured by the network side device.

In an implementation, the third information may be encompassed in a CSI report config.

In the implementation, the first information may be indicated or configured by the network side device.

As an optional implementation, the step that the terminal performs, based on first AI network models corresponding to M groups of second channel information respectively, first processing on the M groups of second channel information, and obtains M pieces of channel feature information includes:
the terminal performs target normalization processing on the M groups of second channel information separately, and obtains M groups of third channel information; and
the terminal performs first processing on the M groups of third channel information based on first AI network models corresponding to the M groups of third channel information respectively, and obtains the M pieces of channel feature information.

Optionally, the target normalization processing includes at least one of the following:
maximum value normalization processing; and
power normalization processing.

The maximum value normalization processing may be to separately divide each element in the M groups of second channel information by an element having the greatest amplitude, and obtain the M groups of third channel information obtained after the maximum value normalization processing.

In an implementation, the maximum value normalization processing may be to centrally perform normalization processing on the M groups of second channel information. In this case, the element having the greatest amplitude is selected from the M groups of second channel information, and each element in the M groups of second channel information is divided by the element having the greatest amplitude, so as to obtain the M groups of third channel information obtained after the maximum value normalization processing.

In an implementation, the maximum value normalization processing may be to perform normalization processing on each of the M groups of second channel information. In this case, the element having the greatest amplitude is selected from one group of second channel information, and each element in the one group of second channel information is divided by the element having the greatest amplitude, so as to obtain one group of third channel information obtained after the maximum value normalization processing, and so on, so as to obtain the M groups of third channel information.

The above power normalization processing may be to perform normalization processing on an element in the second channel information based on a power adjustment factor. Similar to the above maximum value normalization processing, the power normalization processing may alternatively be to centrally perform normalization processing on the M groups of second channel information, or perform normalization processing on each of the M groups of second channel information, which will not be repeated herein.

In the implementation, the channel information input to the first AI network model is a channel matrix or precoding matrix obtained after the normalization processing. For example: before the channel information corresponding to each group of CSI-RS transmission ports is input to the first AI network model, the normalization processing is performed. Or some contents of a normalized precoding matrix, for example, results obtained after power normalization or maximum value normalization is performed on some elements of a column vector having 32elements corresponding to 32 CSI-RS transmission ports, are input to the first AI network model. Or a result obtained after normalization processing is performed on a precoding matrix corresponding to each group of CSI-RS transmission ports is input to the first AI network model.

It should be noted that the channel information input to the first AI network model may be a channel matrix or precoding matrix without normalization processing. For example: a channel matrix without normalization processing is input to the first AI network model. Or some contents of the precoding matrix without normalization processing are input to the first AI network model. For example, assuming that a precoding matrix corresponding to 32 ports is a vector having 32 elements, a coefficient corresponding to one group of CSI-RS transmission ports may be directly input to the first AI network model, which is not specifically limited herein.

Optionally, the method for transmitting information further includes:
the terminal transmits fourth information to the network side device, where the fourth information includes a phase and/or amplitude relationship between M groups of CSI-RS transmission ports corresponding to the M groups of second channel information.

During implementation, in a case that normalization processing is performed on the channel information of different groups of CSI-RS transmission ports separately before the channel information is input to the first AI network model, different normalization processing may be performed on the channel information of different groups of CSI-RS transmission ports, and the terminal needs to additionally report an amplitude and/or phase difference (corresponding to the maximum value normalization processing) or a power adjustment factor (corresponding to the power normalization processing) between each group of CSI-RS transmission ports.

In an implementation, in a case of plural pieces of second channel information, the fourth information includes a phase and amplitude relationship between the M groups of CSI-RS transmission ports corresponding to the M groups of second channel information.

In an implementation, in a case that a number of the second channel information is a real number, the fourth information includes an amplitude relationship between the M groups of CSI-RS transmission ports corresponding to the M groups of second channel information.

In an implementation, the fourth information may include an amplitude level, in a case that each amplitude level corresponds to an amplitude interval, the above amplitude relationship between the M groups of CSI-RS transmission ports may include an amplitude level difference between the M groups of CSI-RS transmission ports.

Optionally, in a case that two groups of CSI-RS transmission ports are located in a same amplitude interval, an amplitude relationship between these two groups of CSI-RS transmission ports may not be reported. For example: in a case of the plural pieces of second channel information, if two groups of CSI-RS transmission ports are located in the same amplitude interval, a phase relationship instead of an amplitude relationship between these two groups of CSI-RS transmission ports may be reported.

In the implementation, the terminal also reports an amplitude and/or phase difference or a power adjustment factor between the channel information of each group of CSI-RS transmission ports to the network side device. The network side device may restore a true value of the second channel information based on the above-obtained amplitude and/or phase difference or the power adjustment factor between the channel information of each group of CSI-RS transmission ports.

Optionally, the phase and/or amplitude relationship between the M groups of CSI-RS transmission ports includes:
an amplitude and/or phase difference between the first group of CSI-RS transmission ports and the second group of CSI-RS transmission ports, where the first group of CSI-RS transmission ports is a group in which the strongest CSI-RS transmission port in the M groups of CSI-RS transmission ports is located or a group of the strongest CSI-RS transmission ports in the M groups of CSI-RS transmission ports, and the second group of CSI-RS transmission ports is each group of CSI-RS transmission ports in the M groups of CSI-RS transmission ports except for the first group of CSI-RS transmission ports.

Optionally, the phase and/or amplitude relationship includes at least one of the following:
a phase difference between a first CSI-RS transmission port and a second CSI-RS transmission port, where the first CSI-RS transmission port is the strongest CSI-RS transmission port in the first group of CSI-RS transmission ports, and the second CSI-RS transmission port includes the strongest CSI-RS transmission port in the second group of CSI-RS transmission ports;
an amplitude difference between the first CSI-RS transmission port and the second CSI-RS transmission port; and
a power adjustment factor between the first group of CSI-RS transmission ports and the second group of CSI-RS transmission ports.

In an implementation, the above phase and/or amplitude relationship between the M groups of CSI-RS transmission ports may be a phase difference and/or an amplitude difference. For example: maximum value normalization processing is performed, based on the strongest element W1 in a first group of second channel information, on the first group of second channel information corresponding to the first group of CSI-RS transmission ports, and maximum value normalization processing is performed, based on the strongest element W2 in a second group of second channel information, on the second group of second channel information corresponding to the second group of CSI-RS transmission ports. In this case, a phase relationship between the first group of CSI-RS transmission ports and the second group of CSI-RS transmission ports includes a phase difference between W1 and W2, and an amplitude relationship between the first group of CSI-RS transmission ports and the second group of CSI-RS transmission ports includes an amplitude difference between W1 and W2.

It should be noted that in a case that the power normalization processing is performed on the M groups of second channel information separately, the above phase and/or amplitude relationship may include the power adjustment factor. The power adjustment factor may be a ratio of total power of one group of CSI-RS transmission ports to total power of the M groups of CSI-RS transmission ports.

Optionally, the method for transmitting information further includes:
the terminal transmits identifiers of the first group of CSI-RS transmission ports to the network side device.

In the implementation, the terminal notifies the network side device of one group of CSI-RS transmission ports that is the strongest group of CSI-RS transmission ports. In this way, the network side device may restore second channel information of another group of CSI-RS transmission ports based on second channel information corresponding to the strongest group of CSI-RS transmission ports.

As an optional implementation, a mapping relationship between the second channel information and the first AI network model satisfies at least one of the following:
the M groups of second channel information corresponds to a same first AI network model;
the network side device indicates the first AI network models corresponding to the M groups of second channel information respectively; and
a number of CSI-RS transmission ports in a group of CSI-RS transmission ports corresponding to target second channel information matches an input dimension of a first AI network model corresponding to the target second channel information, where the M groups of second channel information includes the target second channel information.

In an implementation, the M groups of second channel information are equal in length. In other words, the M groups of CSI-RS transmission ports are equal in number of CSI-RS transmission ports included. In this case, the M groups of second channel information corresponds to the same first AI network model. For example: assuming that the target channel includes X CSI-RS transmission ports, and the value of K is indicated by the base station or agreed on by the protocol, the terminal determines that each group of CSI-RS transmission ports include X÷K CSI-RS transmission ports, and channel information of every X÷K CSI-RS transmission ports is input to the first AI network model as a group, so as to obtain channel feature information corresponding to this group of CSI-RS transmission ports.

In an implementation, the M groups of second channel information corresponds to different first AI network models. In this case, the first AI network models corresponding to all the groups of second channel information respectively may be indicated by the network side device or determined by the terminal.

Optionally, the method for transmitting information further includes:
the terminal transmits third indication information to the network side device, where the third indication information indicates the first AI network models corresponding to the M groups of second channel information respectively.

In the implementation, in a case that the terminal determines the first AI network models corresponding to all the groups of second channel information respectively, the terminal reports the first AI network models corresponding to all the groups of second channel information respectively to the network side device. In this way, the network side device may restore channel feature information output by the encoding AI network model (i.e. the first AI network model) corresponding to the decoding AI network model (i.e. the second AI network model) through the decoding AI network model.

In an implementation, the expression that a number of CSI-RS transmission ports in a group of CSI-RS transmission ports corresponding to target second channel information matches an input dimension of a first AI network model corresponding to the target second channel information may indicate that a length of the target second channel information matches the input dimension of the first AI network model. In this case, if having a same length, the two groups of second channel information may correspond to the same first AI network model.

As an optional implementation, the first channel information is channel information of a same layer of a target downlink channel, and a rank of the target downlink channel is greater than or equal to 1.

In the implementation, channel information of each layer is independently processed, but the same first AI network model may be used for second channel information of different layers.

In an implementation, CSI-RS transmission ports corresponding to different layers may have same grouping information. For example: CSI-RS transmission ports corresponding to a layer 1 are divided into 3 groups, and CSI-RS transmission ports corresponding to a layer 2 are also divided into 3 groups. In this case, one group of CSI-RS transmission ports of the layer 1 and one group of CSI-RS transmission ports of the layer 2 may correspond to the same first AI network model.

Optionally, the 3 groups of CSI-RS transmission ports of the layer 1 and the 3 groups of CSI-RS transmission ports of the layer 2 may correspond to the same first AI network model.

In an implementation, in a case that the phase and/or amplitude relationship between the M groups of CSI-RS transmission ports are/is reported, phase and/or amplitude relationships between different groups of CSI-RS transmission ports in each layer may be calculated respectively. Or, with all layers of the target downlink channel as a whole, phase and/or amplitude relationships between the CSI-RS transmission ports of all the layers are calculated.

In the embodiments of the disclosure, the CSI-RS transmission ports are grouped, and the channel information of each group of CSI-RS transmission ports is processed by one corresponding AI network model. First channel information of one channel may be divided into K groups. Only channel information of one corresponding group of CSI-RS transmission ports, instead of channel information of all CSI-RS transmission ports, is input to each AI network model. In this way, the AI network model having a smaller number of CSI-RS transmission ports can process the channel information having a greater number of CSI-RS transmission ports, so that multiplexing efficiency and flexibility of the AI network model are improved.

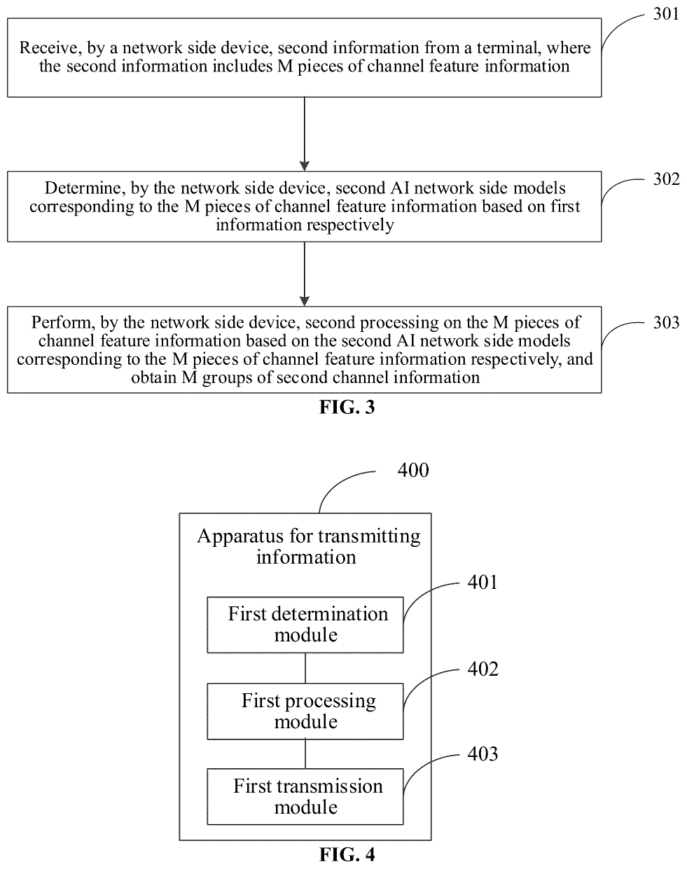

With reference to FIG. 3, a method for processing information according to the embodiments of the disclosure is shown. An execution subject for the method may be a network side device. As shown in FIG. 3, the method for processing information may include:

Step 301, the network side device receives second information from a terminal, where the second information includes M pieces of channel feature information, and the M pieces of channel feature information is channel feature information obtained by performing first processing on M groups of second channel information based on first AI network models corresponding to the M groups of second channel information respectively.

The above second information has the same meaning as the second information in the method embodiment shown in FIG. 2, and is not repeated herein.

Step 302, the network side device determines second AI network models corresponding to the M pieces of channel feature information based on first information respectively, where the first information includes grouping information of K groups of channel state information-reference signal (CSI-RS) transmission ports, K groups of second channel information corresponds one-to-one to the K groups of CSI-RS transmission ports, each of the K groups of CSI-RS transmission ports includes at least one CSI-RS transmission port, the K groups of second channel information includes the M groups of second channel information, and K and M are integers greater than or equal to 1.

The above first information has a same meaning as the first information in the method embodiment shown in FIG. 2. The network side device is configured to determine the second AI network models corresponding to the M pieces of channel feature information based on the first information respectively, and obtain the first AI network model of the channel feature information. The second AI network models corresponding to the channel feature information are AI network models matching each other or AI network models obtained by joint training. For example: the first AI network model is an encoding AI network model or an encoding portion of an AI network model, and the second AI network model is a decoding AI network model or a decoding portion of an Al network model.

Step 303, the network side device performs second processing on the M pieces of channel feature information based on the second AI network models corresponding to the M pieces of channel feature information respectively, and obtains the M groups of second channel information.

The second processing may include at least one of decoding, decompression, and dequantization.

As an optional implementation, the first information includes at least one of the following:
a value of K;
a number of CSI-RS transmission ports in each group of CSI-RS transmission ports; and
identifiers of the CSI-RS transmission ports in each group of CSI-RS transmission ports.

As an optional implementation, the first information satisfies at least one of the following: indicated by the network side device;
selected by the terminal; and
agreed on by the protocol.

As an optional implementation, CSI-RS transmission ports located in a same group satisfy at least one of the following:
polarization directions are the same;
corresponding transmission antennas are located in a same row;
corresponding transmission antennas are located in a same column;
time-domain resources are the same;
frequency-domain resources are the same;
code division multiple (CDM) manners are the same; and
N CSI-RS transmission ports continuously arranged in CSI-RS transmission ports for the first channel information are included, where N is an integer greater than or equal to 1, and the first channel information is channel information of all CSI-RS transmission ports of channels corresponding to the M groups of second channel information.

As an optional implementation, the first channel information includes at least one of the following:
an original channel matrix or vector;
a precoding matrix or vector;
a preprocessed channel matrix or vector; and
a preprocessed precoding matrix or vector.

In an implementation, in a case that the first channel information is channel information of one layer, a channel matrix corresponding to the channel information of the layer has only one column. In this case, the second channel information may be referred to as a vector. Certainly, in a case that the second channel information includes channel information of at least two layers, the channel information of the at least two layers or may be preprocessed into vectors, which is not specifically described herein.

As an optional implementation, one group of second channel information includes at least one of the following:
an original channel matrix corresponding to one group of CSI-RS transmission ports, where the one group of CSI-RS transmission ports correspond to the one group of second channel information;
a matrix, formed by elements corresponding to the one group of CSI-RS transmission ports, in a first precoding matrix, where the first precoding matrix is a precoding matrix of the first channel information; and
a second precoding matrix, where the second precoding matrix is a precoding matrix of the one group of second channel information.

Optionally, the method for processing information further includes:
the network side device determines the first channel information or a precoding matrix corresponding to the first channel information based on the M groups of second channel information.

In an implementation, the network side device may perform splicing based on to the M groups of second channel information, and obtain the first precoding matrix.

As an optional embodiment, before the step that the network side device determines second AI network models corresponding to the M pieces of channel feature information based on first information respectively, the method for processing information further includes:
the network side device receives first indication information from the terminal, where the first indication information indicates the first information.

As an optional implementation, before the step that the network side device receives second information from a terminal, the method for processing information further includes:
the network side device transmits third information to the terminal; where
the third information indicates or configures the first information; or the third information indicates a first identifier, the first identifier is associated with the first information, and the terminal acquires a first association relationship between the first information and the first identifier.

As an optional implementation, the M pieces of channel feature information are channel feature information obtained by performing, based on first AI network models corresponding to M groups of third channel information respectively, first processing on the M groups of third channel information, where the M groups of third channel information is channel information obtained after target normalization processing is performed on the M groups of second channel information.

As an optional implementation, the target normalization processing includes at least one of the following:
maximum value normalization processing; and
power normalization processing.

As an optional implementation, the step that the network side device performs second processing on the M pieces of channel feature information based on the second AI network models corresponding to the M pieces of channel feature information respectively, and obtains the M groups of second channel information includes:
the network side device receives fourth information from the terminal, where the fourth information includes a phase and/or amplitude relationship between M groups of CSI-RS transmission ports corresponding to the M groups of second channel information;
the network side device performs the second processing on the M pieces of channel feature information based on the second AI network models corresponding to the M pieces of channel feature information respectively, and obtains the M groups of third channel information; and
the network side device processes the M groups of third channel information into the M groups of second channel information based on the fourth information.

In an implementation, the step that the network side device processes the M groups of third channel information into the M groups of second channel information based on the fourth information may indicate that the network side device performs inverse processing of the target normalization processing on the M groups of third channel information based on the fourth information, so as to restore the M groups of second channel information before the target normalization processing.

As an optional implementation, the phase and/or amplitude relationship between the M groups of CSI-RS transmission ports includes:
an amplitude and/or phase difference between a first group of CSI-RS transmission ports and a second group of CSI-RS transmission ports, where the first group of CSI-RS transmission ports is a group in which the strongest CSI-RS transmission port in the M groups of CSI-RS transmission ports is located or a group of the strongest CSI-RS transmission ports in the M groups of CSI-RS transmission ports, and the second group of CSI-RS transmission ports is each group of CSI-RS transmission ports in the M groups of CSI-RS transmission ports except for the first group of CSI-RS transmission ports.

As an optional implementation, the method for processing information further includes:
the network side device receives identifiers of the first group of CSI-RS transmission ports from the terminal.

As an optional implementation, the phase and/or amplitude relationship includes at least one of the following:
a phase difference between a first CSI-RS transmission port and a second CSI-RS transmission port, where the first CSI-RS transmission port is the strongest CSI-RS transmission port in the first group of CSI-RS transmission ports, and the second CSI-RS transmission port includes the strongest CSI-RS transmission port in the second group of CSI-RS transmission ports;
an amplitude difference between the first CSI-RS transmission port and the second CSI-RS transmission port; and
a power adjustment factor between the first group of CSI-RS transmission ports and the second group of CSI-RS transmission ports.

As an optional implementation, a mapping relationship between the second channel information and the first AI network model satisfies at least one of the following:
the M groups of second channel information corresponds to a same first AI network model;
the network side device indicates the first AI network models corresponding to the M groups of second channel information respectively; and
a number of CSI-RS transmission ports in a group of CSI-RS transmission ports corresponding to target second channel information matches an input dimension of a first AI network model corresponding to the target second channel information, where the M groups of second channel information includes the target second channel information.

As an optional implementation, the method for processing information further includes:
the network side device receives third indication information from the terminal, where the third indication information indicates the first AI network models corresponding to the M groups of second channel information respectively.

In the implementation, the terminal selects and reports the first AI network models corresponding to the M groups of second channel information respectively. In this way, the network side device may determine the second AI network models corresponding to the M groups of second channel information respectively based on the first AI network models corresponding to the M groups of second channel information respectively. The first AI network model and the second AI network model corresponding to a same group of second channel information are an encoding AI network model and a decoding AI network model matching each other or obtained by joint training.

As an optional implementation, the first channel information is channel information of a same layer of a target downlink channel, and a rank of the target downlink channel is greater than or equal to 1.

In the embodiment of the disclosure, the network side device receives the M pieces of channel feature information from the terminal, and determines the second AI network models corresponding to the M pieces of channel feature information based on the first information respectively, so as to restore the corresponding channel feature information to the second channel information through the second AI network models. Thus, a process of receiving and restoring the channel feature information is achieved. Channel feature information of some CSI-RS transmission ports serves as an input of the second AI network model, so that the second AI network model has a small size. In addition, by dividing the CSI-RS transmission ports having a same number into one group, the same second AI network model can be repeatedly used for channels having different numbers of CSI-RS transmission ports. In this way, the AI network model having a smaller number of CSI-RS transmission ports can process the channel information having a greater number of CSI-RS transmission ports, so that multiplexing efficiency and flexibility of the AI network model are improved.

For ease of description, with an application scenario in which base station antennas are configured to be 2×8, i.e. 8 antennas in a horizontal direction and 2 antennas in a vertical direction, so as to form a rectangular antenna array, where each antenna is a dual-polar antenna, so that 32 CSI-RS transmission ports are formed, and the terminal has 4 reception antennas as an example, the method for transmitting information and the method for processing information according to the embodiments of the disclosure are illustratively described.

### Embodiment 1

If the first AI network model of the terminal is an AI model input by 16 CSI-RS transmission ports, the terminal may obtain a 4×32 channel matrix through channel estimation; divide the above channel matrix into two 4×16 channel matrices; calculate a corresponding precoding matrix corresponding to each polarization direction, so as to obtain two 16×1 precoding matrices; and input the two 16×1 precoding matrices into the AI model separately. A specific AI processing method is not limited. Preprocessing may be performed. For example, before input to the model, data may be calculated, and the 16×1 matrix is preprocessed into 8×1 matrices. Each sub-band may be independent. For example, 13 sub-bands are grouped separately. Or all or some of the sub-bands may be grouped jointly. For example, 13 sub-bands are grouped jointly.

For example: assuming that H=[H₁H₂], where H denotes a 4×32 channel matrix, and H₁ and H₂ correspond to two polarized channel matrices, a precoding matrix W₁ corresponding to H₁ and a precoding matrix W₂ corresponding to H₂ are calculated respectively:
the terminal calculates an amplitude difference and a phase difference between the two groups of CSI-RS transmission ports:
Method 1: an amplitude difference and a phase difference between a coefficient having the greatest amplitude in W₁ and a coefficient having the greatest amplitude in W₂ are calculated, and the amplitude difference and the phase difference calculated are quantized, and then reported to the base station.
Method 2: an equivalent channel matrix H₁W₁ corresponding to W₁ and an equivalent channel matrix H₂W₂ corresponding to W₂ are calculated, and a power ratio of the two equivalent channels is calculated and reported to the base station.

### Embodiment 2

For 32 CSI-RS transmission ports, a command type (cmd-Type) indication is as follows: cmd8-FD2-TD4. In other words, a CDM group has 8 CDM manners, 2 frequency-domain positions, and 4 time-domain positions. Thus, the CSI-RS transmission ports may be grouped through the following method:
Method 1: the CSI-RS transmission ports are divided into 8 groups, one group is used for each CDM, and each group has 4 ports. Second channel information of each group of CSI-RS transmission ports is input to the corresponding AI model, so as to obtain 8 pieces of channel feature information.
Method 2: the CSI-RS transmission ports are divided into 4 groups, one group is used for each time-frequency position, and each group has 8 ports. Second channel information of each group of CSI-RS transmission ports is input to the corresponding AI model, so as to obtain 4 groups of channel feature information.

An execution subject for the method for transmitting information according to the embodiments of the disclosure may be an apparatus for transmitting information. In the embodiments of the disclosure, the apparatus for transmitting information according to the embodiments of the disclosure is described with the apparatus for transmitting information executing the method for transmitting information as an example.

With reference to FIG. 4, an apparatus for transmitting information according to the embodiments of the disclosure may be an apparatus in the terminal. As shown in FIG. 4, the apparatus 400 for transmitting information may include:
a first determination module 401 configured to determine K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1;
a first processing module 402 configured to perform, based on first AI network models corresponding to M groups of second channel information respectively, first processing on the M groups of second channel information, and obtain M pieces of channel feature information, where the K groups of second channel information includes the M groups of second channel information; and
a first transmission module 403 configured to transmit second information to a network side device, where the second information includes the M pieces of channel feature information.

Optionally, the first information includes at least one of the following:
a value of K;
a number of CSI-RS transmission ports in each group of CSI-RS transmission ports; and
identifiers of the CSI-RS transmission ports in each group of CSI-RS transmission ports.

Optionally, the first information satisfies at least one of the following:
indicated by the network side device;
selected by the terminal; and
agreed on by the protocol.

Optionally, CSI-RS transmission ports located in a same group satisfy at least one of the following:
polarization directions are the same;
corresponding transmission antennas are located in a same row;
corresponding transmission antennas are located in a same column;
time-domain resources are the same;
frequency-domain resources are the same;
code division multiple (CDM) manners are the same; and
N CSI-RS transmission ports continuously arranged in all CSI-RS transmission ports for the first channel information are included, where N is an integer greater than or equal to 1.

Optionally, the first channel information includes at least one of the following:
an original channel matrix or vector;
a precoding matrix or vector;
a preprocessed channel matrix or vector; and
a preprocessed precoding matrix or vector.

Optionally, one group of second channel information includes at least one of the following:
an original channel matrix corresponding to one group of CSI-RS transmission ports,
where the one group of CSI-RS transmission ports correspond to the one group of second channel information;
a matrix, formed by elements corresponding to the one group of CSI-RS transmission ports, in a first precoding matrix, where the first precoding matrix is a precoding matrix of the first channel information; and
a second precoding matrix, where the second precoding matrix is a precoding matrix of the one group of second channel information.

Optionally, the apparatus 400 for transmitting information further includes:
a third determination module configured to determine the first information based on the first AI network models possessed; and
a second transmission module configured to transmit first indication information to the network side device, where the first indication information indicates the first information.

Optionally, the apparatus 400 for transmitting information further includes:
a second reception module configured to receive third information from the network side device; where
the third information indicates or configures the first information; or the third information indicates a first identifier, the first identifier is associated with the first information, and the terminal acquires a first association relationship between the first information and the first identifier.

Optionally, the first processing module 402 includes:
a first processing unit configured to perform target normalization processing on the M groups of second channel information respectively, and obtain M groups of third channel information; and
a second processing unit configured to perform first processing on the M groups of third channel information based on first AI network models corresponding to the M groups of third channel information respectively, and obtain M pieces of channel feature information.

Optionally, the target normalization processing includes at least one of the following:
maximum value normalization processing; and
power normalization processing.

Optionally, the apparatus 400 for transmitting information further includes:
a third transmission module configured to transmit fourth information to the network side device, where the fourth information includes a phase and/or amplitude relationship between M groups of CSI-RS transmission ports corresponding to the M groups of second channel information.

Optionally, the phase and/or amplitude relationship between the M groups of CSI-RS transmission ports includes:
an amplitude and/or phase difference between a first group of CSI-RS transmission ports and a second group of CSI-RS transmission ports, where the first group of CSI-RS transmission ports is a group in which the strongest CSI-RS transmission port in the M groups of CSI-RS transmission ports is located or a group of the strongest CSI-RS transmission ports in the M groups of CSI-RS transmission ports, and the second group of CSI-RS transmission ports is each group of CSI-RS transmission ports in the M groups of CSI-RS transmission ports except for the first group of CSI-RS transmission ports.

Optionally, the apparatus 400 for transmitting information further includes:
a fourth transmission module configured to transmit identifiers of the first group of CSI-RS transmission ports to the network side device.

Optionally, the phase and/or amplitude relationship includes at least one of the following:
a phase difference between a first CSI-RS transmission port and a second CSI-RS transmission port, where the first CSI-RS transmission port is the strongest CSI-RS transmission port in the first group of CSI-RS transmission ports, and the second CSI-RS transmission port includes the strongest CSI-RS transmission port in the second group of CSI-RS transmission ports;
an amplitude difference between the first CSI-RS transmission port and the second CSI-RS transmission port; and
a power adjustment factor between the first group of CSI-RS transmission ports and the second group of CSI-RS transmission ports.

Optionally, a mapping relationship between the second channel information and the first AI network model satisfies at least one of the following:
the M groups of second channel information corresponds to a same first AI network model;
the network side device indicates the first AI network models corresponding to the M groups of second channel information respectively; and
a number of CSI-RS transmission ports in a group of CSI-RS transmission ports corresponding to target second channel information matches an input dimension of a first AI network model corresponding to the target second channel information, where the M groups of second channel information includes the target second channel information.

Optionally, the apparatus 400 for transmitting information further includes:
a fifth transmission module configured to transmit third indication information to the network side device, where the third indication information indicates the first AI network models corresponding to the M groups of second channel information respectively.

Optionally, the first channel information is channel information of a same layer of a target downlink channel, and a rank of the target downlink channel is greater than or equal to 1.

The apparatus for transmitting information in the embodiments of the disclosure may be an electronic device, for example, an electronic device having an operating system, or a component in an electronic device, for example, an integrated circuit or a chip. The electronic device may be a terminal, or may be another device except for the terminal. For example, the terminal may include, but is not limited to, the above type of terminal 11, and another device may be a server, a network attached storage (NAS), etc., which is not specifically limited in the embodiments of the disclosure.

The apparatus 400 for transmitting information according to the embodiments of the disclosure can implement various processes implemented by the terminal in the method embodiment shown in FIG. 2, and achieve the same technical effects, which will not be repeated herein to avoid repetitions.

An execution subject for the method for processing information according to the embodiments of the disclosure may be an apparatus for processing information. In the embodiments of the disclosure, the apparatus for processing information according to the embodiments of the disclosure is described with the apparatus for processing information executing the information for processing information as an example.

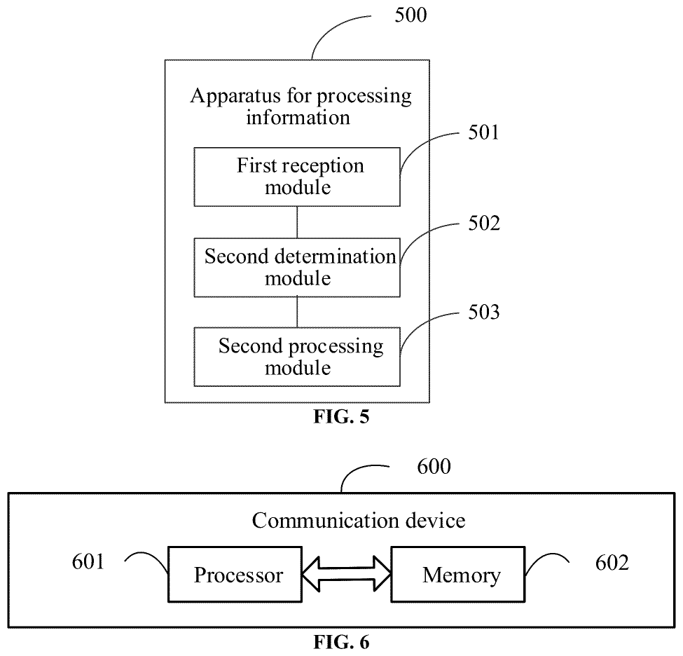

With reference to FIG. 5, an apparatus for processing information according to the embodiments of the disclosure may be an apparatus in the network side device. As shown in FIG. 5, the apparatus 500 for processing information may include:
a first reception module 501 configured to receive second information from a terminal, where the second information includes M pieces of channel feature information, and the M pieces of channel feature information is channel feature information obtained by performing, based on first Al network models corresponding to M groups of second channel information respectively, first processing on the M groups of second channel information;
a second determination module 502 configured to determine second AI network models corresponding to the M pieces of channel feature information based on first information respectively, where the first information includes grouping information of K groups of channel state information-reference signal (CSI-RS) transmission ports, K groups of second channel information corresponds one-to-one to the K groups of CSI-RS transmission ports, each of the K groups of CSI-RS transmission ports includes at least one CSI-RS transmission port, the K groups of second channel information includes the M groups of second channel information, and K and M are integers greater than or equal to 1; and
a second processing module 503 configured to perform second processing on the M pieces of channel feature information based on the second AI network models corresponding to the M pieces of channel feature information respectively, and obtain the M groups of second channel information.

Optionally, the first information includes at least one of the following:
a value of K;
a number of CSI-RS transmission ports in each group of CSI-RS transmission ports; and
identifiers of the CSI-RS transmission ports in each group of CSI-RS transmission ports.

Optionally, the first information satisfies at least one of the following:
indicated by the network side device;
selected by the terminal; and
agreed on by the protocol.

Optionally, CSI-RS transmission ports located in a same group satisfy at least one of the following:
polarization directions are the same;
corresponding transmission antennas are located in a same row;
corresponding transmission antennas are located in a same column;
time-domain resources are the same;
frequency-domain resources are the same;
code division multiple (CDM) manners are the same; and
N CSI-RS transmission ports continuously arranged in CSI-RS transmission ports for the

first channel information are included, where N is an integer greater than or equal to 1, and the first channel information is channel information of all CSI-RS transmission ports of channels corresponding to the M groups of second channel information.

Optionally, the first channel information includes at least one of the following:
an original channel matrix or vector;
a precoding matrix or vector;
a preprocessed channel matrix or vector; and
a preprocessed precoding matrix or vector.

Optionally, one group of second channel information includes at least one of the following:
an original channel matrix corresponding to one group of CSI-RS transmission ports, where the one group of CSI-RS transmission ports correspond to the one group of second channel information;
a matrix, formed by elements corresponding to the one group of CSI-RS transmission ports, in a first precoding matrix, where the first precoding matrix is a precoding matrix of the first channel information; and
a second precoding matrix, where the second precoding matrix is a precoding matrix of the one group of second channel information.

Optionally, the apparatus 500 for processing information further includes:
a fourth determination module configured to determine the first channel information or a precoding matrix corresponding to the first channel information based on the M groups of second channel information.

Optionally, the apparatus 500 for processing information further includes:
a third reception module configured to receive first indication information from the terminal, where the first indication information indicates the first information.

Optionally, the apparatus 500 for processing information further includes:
a sixth transmission module configured to transmit third information to the terminal; where
the third information indicates or configures the first information; or the third information indicates a first identifier, the first identifier is associated with the first information, and the terminal acquires a first association relationship between the first information and the first identifier.

Optionally, the M pieces of channel feature information is channel feature information obtained by performing, based on first AI network models corresponding to M groups of third channel information, first processing on the M groups of third channel information, and the M groups of third channel information is channel information obtained by performing target normalization processing on the M groups of second channel information.

Optionally, the target normalization processing includes at least one of the following:
maximum value normalization processing; and
power normalization processing.

Optionally, the second processing module 503 includes:
a reception unit configured to receive fourth information from the terminal, where the fourth information includes a phase and/or amplitude relationship between M groups of CSI-RS transmission ports corresponding to the M groups of second channel information;
a third processing unit configured to perform second processing on the M pieces of channel feature information based on the second AI network models corresponding to the M pieces of channel feature information respectively, and obtain the M groups of third channel information; and
a fourth processing unit configured to process the M groups of third channel information into the M groups of second channel information based on the fourth information.

Optionally, the phase and/or amplitude relationship between the M groups of CSI-RS transmission ports includes:
an amplitude and/or phase difference between a first group of CSI-RS transmission ports and a second group of CSI-RS transmission ports, where the first group of CSI-RS transmission ports is a group in which the strongest CSI-RS transmission port in the M groups of CSI-RS transmission ports is located or a group of the strongest CSI-RS transmission ports in the M groups of CSI-RS transmission ports, and the second group of CSI-RS transmission ports is each group of CSI-RS transmission ports in the M groups of CSI-RS transmission ports except for the first group of CSI-RS transmission ports.

Optionally, the apparatus 500 for processing information further includes:
a fourth reception module configured to receive identifiers of the first group of CSI-RS transmission ports from the terminal.

Optionally, the phase and/or amplitude relationship includes at least one of the following:
a phase difference between a first CSI-RS transmission port and a second CSI-RS transmission port, where the first CSI-RS transmission port is the strongest CSI-RS transmission port in the first group of CSI-RS transmission ports, and the second CSI-RS transmission port includes the strongest CSI-RS transmission port in the second group of CSI-RS transmission ports;
an amplitude difference between the first CSI-RS transmission port and the second CSI-RS transmission port; and
a power adjustment factor between the first group of CSI-RS transmission ports and the second group of CSI-RS transmission ports.

Optionally, a mapping relationship between the second channel information and the first AI network model satisfies at least one of the following:
the M groups of second channel information corresponds to a same first AI network model;
the network side device indicates the first AI network models corresponding to the M groups of second channel information respectively; and
a number of CSI-RS transmission ports in a group of CSI-RS transmission ports corresponding to target second channel information matches an input dimension of a first AI network model corresponding to the target second channel information, where the M groups of second channel information includes the target second channel information.

Optionally, the apparatus 500 for processing information further includes:
a fifth reception module configured to receive third indication information from the terminal, where the third indication information indicates the first AI network models corresponding to the M groups of second channel information respectively.

Optionally, the first channel information is channel information of a same layer of a target downlink channel, and a rank of the target downlink channel is greater than or equal to 1.

The apparatus 500 for processing information according to the embodiments of the disclosure can implement various processes implemented by the network side device in the method embodiment shown in FIG. 3, and achieve the same technical effects, which will not be repeated herein to avoid repetitions.

Optionally, as shown in FIG. 6, a communication device 600 is further provided in the embodiments of the disclosure. The communication device includes a processor 601 and a memory 602; where the memory 602 stores a program or instruction runnable on the processor 601. For example, in a case that the communication device 600 is a terminal, the program or instruction implements each step in the method embodiment shown in FIG. 2 when executed by the processor 601, and achieves the same technical effects. In a case that the communication device 600 is a network side device, the program or instruction implements each step in the method embodiment shown in FIG. 3 when executed by the processor 601, and achieves the same technical effects, which will not be repeated herein to avoid repetitions.

A terminal is further provided in the embodiments of the disclosure. The terminal includes a processor and a communication interface; where the processor is configured to determine K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1; the processor is further configured to perform, based on first AI network models corresponding to M groups of second channel information respectively, first processing on the M groups of second channel information, and obtain M pieces of channel feature information, where the K groups of second channel information includes the M groups of second channel information; and the communication interface is configured to transmit second information to a network side device, where the second information includes the M pieces of channel feature information.

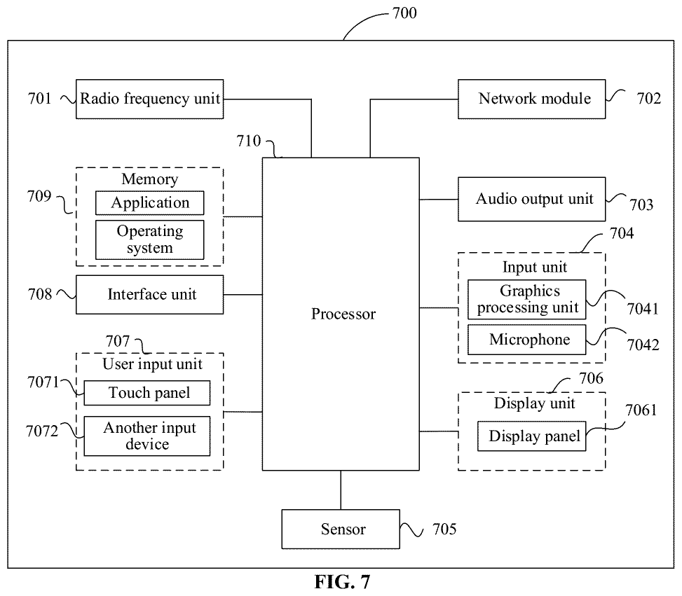

The terminal embodiment can implement various processes executed by the apparatus 400 for transmitting information shown in FIG. 4, and achieve the same technical effects, which will not be repeated herein. Specifically, FIG. 7 is a schematic structural diagram of hardware of a terminal according to an embodiment of the disclosure.

The terminal 700 includes, but is not limited to, at least some of a radio frequency unit 701, a network module 702, an audio output unit 703, an input unit 704, a sensor 705, a display unit 706, a user input unit 707, an interface unit 708, a memory 709, a processor 710, etc.

Those skilled in the art can understand that the terminal 700 may further include a power supply (such as a battery) for supplying power to the various components. The power supply may be logically connected to the processor 710 through a power supply management system, so that functions such as charging, discharging, and power consumption management are implemented through the power supply management system. The terminal structure shown in FIG. 7 is not intended to limit the terminal. The terminal may include more or fewer components than shown, combine some components, or have different component arrangements, which will not be repeated herein.

It should be understood that in the embodiments of the disclosure, the input unit 704 may include a graphics processing unit (GPU) 7041 and a microphone 7042. The graphics processing unit 7041 processes on image data of a static picture or a video obtained by an image capture apparatus (for example, a camera) in a video capture mode or image capture mode. The display unit 706 may include a display panel 7061. The display panel 7061 may be configured by a liquid crystal display, an organic light emitting diode, etc. The user input unit 707 includes at least one of a touch panel 7071 and another input device 7072. The touch panel 7071 is also referred to as a touch screen. The touch panel 7071 may include a touch detection apparatus and a touch controller. Another input device 7072 may include, but is not limited to, a physical keyboard, a function key (such as a volume control key and a switch key), a track ball, a mouse, and a joystick, which will not be repeated herein.

In the embodiments of the disclosure, after receiving downlink data from a network side device, the radio frequency unit 701 may transmit the downlink data to the processor 710 for processing. In addition, the radio frequency unit 701 may transmit uplink data to the network side device. Generally, the radio frequency unit 701 includes, but is not limited to, an antenna, an amplifier, a transceiver, a coupler, a low noise amplifier, a duplexer, etc.

The memory 709 may be configured to store a software program or instruction and various data. The memory 709 may mainly include a first storage area for storing the program or instruction and a second storage area for storing the data. The first storage area may store an operating system, an application or instruction required by at least one function (for example, a sound playback function and an image display function), etc. In addition, the memory 709 may include a volatile memory or a non-volatile memory. Or the memory 709 may include a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a direct rambus RAM (DRRAM). The memory 709 in the embodiments of the disclosure includes, but not limited to, these memories and any other suitable types of memories.

The processor 710 may include one or more processing units. Optionally, the processor 710 integrates an application processor and a modem processor; where the application processor mainly processes operations involving an operating system, a user interface, an application, etc.; and the modem processor mainly processes a radio communication signal, such as a baseband processor. It can be understood that the above modem processor may not be integrated into the processor 710.

The processor 710 is configured to determine K groups of second channel information from first channel information based on first information, where the first information includes grouping information of K groups of channel state information-reference signal (CSI-RS) transmission ports, the K groups of second channel information corresponds one-to-one to the K groups of CSI-RS transmission ports, each of the K groups of CSI-RS transmission ports includes at least one CSI-RS transmission port, and K is an integer greater than or equal to 1.

The processor 710 is further configured to perform, based on first AI network models corresponding to M groups of second channel information respectively, first processing on the M groups of second channel information, and obtain M pieces of channel feature information, where the K groups of second channel information includes the M groups of second channel information.

The radio frequency unit 701 is further configured to transmit second information to a network side device, where the second information includes the M pieces of channel feature information.

Optionally, the first information includes at least one of the following:
a value of K;
a number of CSI-RS transmission ports in each group of CSI-RS transmission ports; and
identifiers of the CSI-RS transmission ports in each group of CSI-RS transmission ports.

Optionally, the first information satisfies at least one of the following:
indicated by the network side device;
selected by the terminal; and
agreed on by the protocol.

Optionally, CSI-RS transmission ports located in a same group satisfy at least one of the following:
polarization directions are the same;
corresponding transmission antennas are located in a same row;
corresponding transmission antennas are located in a same column;
time-domain resources are the same;
frequency-domain resources are the same;
code division multiple (CDM) manners are the same; and
N CSI-RS transmission ports continuously arranged in all CSI-RS transmission ports for the first channel information are included, where N is an integer greater than or equal to 1.

Optionally, the first channel information includes at least one of the following:
an original channel matrix or vector;
a precoding matrix or vector;
a preprocessed channel matrix or vector; and
a preprocessed precoding matrix or vector.

Optionally, one group of second channel information includes at least one of the following:
an original channel matrix corresponding to one group of CSI-RS transmission ports, where the one group of CSI-RS transmission ports correspond to the one group of second channel information;
a matrix, formed by elements corresponding to the one group of CSI-RS transmission ports, in a first precoding matrix, where the first precoding matrix is a precoding matrix of the first channel information; and
a second precoding matrix, where the second precoding matrix is a precoding matrix of the one group of second channel information.

Optionally, the processor 710 is further configured to determine the first information based on the first AI network model possessed; and
the radio frequency unit 701 is further configured to transmit first indication information to the network side device, where the first indication information indicates the first information.

Optionally, before the processor 710 determines the K groups of second channel information from the first channel information based on the first information, the radio frequency unit 701 is further configured to receive third information from the network side device; where
the third information indicates or configures the first information; or the third information indicates a first identifier, the first identifier is associated with the first information, and the terminal acquires a first association relationship between the first information and the first identifier.

Optionally, the M pieces of channel feature information is obtained by performing, by the processor 710, based on first AI network models corresponding to the M groups of second channel information respectively, the first processing on the M groups of second channel information as follows:
target normalization processing is performed on the M groups of second channel information separately, and M groups of third channel information is obtained; and
first processing is performed on the M groups of third channel information based on first AI network models corresponding to the M groups of second channel information respectively, and the M pieces of channel feature information is obtained.

Optionally, the target normalization processing includes at least one of the following:
maximum value normalization processing; and
power normalization processing.

Optionally, the radio frequency unit 701 is further configured to transmit fourth information to the network side device, where the fourth information includes a phase and/or amplitude relationship between M groups of CSI-RS transmission ports corresponding to the M groups of second channel information.

Optionally, the phase and/or amplitude relationship between the M groups of CSI-RS transmission ports includes:
an amplitude and/or phase difference between a first group of CSI-RS transmission ports and a second group of CSI-RS transmission ports, where the first group of CSI-RS transmission ports is a group in which the strongest CSI-RS transmission port in the M groups of CSI-RS transmission ports is located or a group of the strongest CSI-RS transmission ports in the M groups of CSI-RS transmission ports, and the second group of CSI-RS transmission ports is each group of CSI-RS transmission ports in the M groups of CSI-RS transmission ports except for the first group of CSI-RS transmission ports.

Optionally, the radio frequency unit 701 is further configured to transmit identifiers of the first group of CSI-RS transmission ports to the network side device.

Optionally, the phase and/or amplitude relationship includes at least one of the following:
a phase difference between a first CSI-RS transmission port and a second CSI-RS transmission port, where the first CSI-RS transmission port is the strongest CSI-RS transmission port in the first group of CSI-RS transmission ports, and the second CSI-RS transmission port includes the strongest CSI-RS transmission port in the second group of CSI-RS transmission ports;
an amplitude difference between the first CSI-RS transmission port and the second CSI-RS transmission port; and
a power adjustment factor between the first group of CSI-RS transmission ports and the second group of CSI-RS transmission ports.

Optionally, a mapping relationship between the second channel information and the first AI network model satisfies at least one of the following:
the M groups of second channel information corresponds to a same first AI network model;
the network side device indicates the first AI network models corresponding to the M groups of second channel information respectively; and
a number of CSI-RS transmission ports in a group of CSI-RS transmission ports corresponding to target second channel information matches an input dimension of a first AI network model corresponding to the target second channel information, where the M groups of second channel information includes the target second channel information.

Optionally, the radio frequency unit 701 is further configured to transmit third indication information to the network side device, where the third indication information indicates the first AI network models corresponding to the M groups of second channel information respectively.

Optionally, the first channel information is channel information of a same layer of a target downlink channel, and a rank of the target downlink channel is greater than or equal to 1.

The terminal 700 according to the embodiments of the disclosure can implement various processes executed by the apparatus for transmitting information shown in FIG. 4, and achieve the same beneficial effects, which will not be repeated herein to avoid repetitions.

A network side device is further provided in the embodiments of the disclosure. The network side device includes a processor and a communication interface; where the communication interface is configured to receive second information from a terminal, the second information includes M pieces of channel feature information, and the M pieces of channel feature information is channel feature information obtained by performing, based on first AI network models corresponding to M groups of second channel information respectively, first processing on the M groups of second channel information; the processor is configured to determine second AI network models corresponding to the M pieces of channel feature information based on first information respectively, where the first information includes grouping information of K groups of channel state information-reference signal (CSI-RS) transmission ports, K groups of second channel information corresponds one-to-one to the K groups of CSI-RS transmission ports, each of the K groups of CSI-RS transmission ports includes at least one CSI-RS transmission port, the K groups of second channel information includes the M groups of second channel information, and K and M are integers greater than or equal to 1; and the processor is further configured to perform second processing on the M pieces of channel feature information based on the second AI network models corresponding to the M pieces of channel feature information respectively, and obtain the M groups of second channel information.

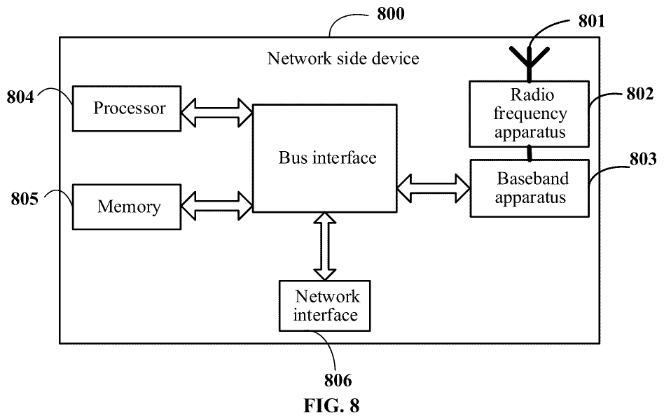

The network side device embodiment can implement various processes executed by the apparatus 500 for processing information shown in FIG. 5, and achieve the same technical effects, which will not be repeated herein. Specifically, a network side device is further provided in the embodiments of the disclosure. As shown in FIG. 8, the network side device 800 includes: an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and transmits the information received to the baseband apparatus 803 for processing. In a downlink direction, the baseband apparatus 803 processes to-be-transmitted information, and transmits the to-be-transmitted information to the radio frequency apparatus 802, and the radio frequency apparatus 802 processes the information received, and transmits the information through the antenna 801.

The method executed by the network side device in the above embodiments may be implemented in the baseband apparatus 803. The baseband apparatus 803 includes a baseband processor.

The baseband apparatus 803 may include, for example, at least one baseband board, and a plurality of chips are arranged on the baseband board. As shown in FIG. 8, one chip such as the baseband processor is connected to the memory 805 through a bus interface, so as to invoke a program in the memory 805, and perform an operation performed by a network device shown in the above method embodiment.

The network side device may further include a network interface 806. The interface is, for example, a common public radio interface (CPRI).

Specifically, the network side device 800 according to the embodiments of the disclosure further includes: an instruction or program stored in the memory 805 and runnable on the processor 804. The processor 804 invokes the instruction or program in the memory 805, so as to execute the method executed by each module shown in FIG. 5, and achieve the same technical effects, which will not be repeated herein to avoid repetitions.

A readable storage medium is further provided in the embodiments of the disclosure. The readable storage medium stores a program or instruction; where the program or instruction, when executed by a processor, implements various processes in the method embodiment shown in FIG. 2 or FIG. 3, and achieves the same technical effects, which will not be repeated herein to avoid repetitions.

The processor is the processor in the terminal in above embodiment. The readable storage medium includes a computer-readable storage medium, such as a computer read-only memory (ROM), a random access memory (RAM), a magnetic disk, and an optical disk.

A chip is further provided in the embodiments of the disclosure. The chip includes a processor and a communication interface; where the communication interface is coupled to the processor, and the processor is configured to run a program or instruction, so as to implement various processes in the method embodiment shown in FIG. 2 or FIG. 3, and achieve the same technical effects, which will not be repeated herein to avoid repetitions.

It should be understood that the chip mentioned in the embodiments of the disclosure may alternatively be referred to as a system on a chip, a system chip, a chip system, a system-on-chip, etc.

A computer program/program product is further provided in the embodiments of the disclosure. The computer program/program product is stored in a storage medium, the computer program/program product is executed by at least one processor, so as to implement various processes in the method embodiment shown in FIG. 2 or FIG. 3, and achieve the same technical effects, which will not be repeated herein to avoid repetitions.

A communication system is further provided in the embodiments of the disclosure. The communication system includes: a terminal and a network side device, where the terminal is capable of being configured to execute steps of the method for transmitting information shown in FIG. 2, and the network side device is capable of being configured to execute steps of the method for processing information shown in FIG. 3.

It should be noted that the terms “include”, “comprise”, “encompass”, or their any other variations herein are intended to cover the non-exclusive inclusion, so that a process, method, article, or apparatus including a series of elements not only includes those elements but also includes other elements not clearly listed, or further includes elements inherent to such a process, method, article, or apparatus. Without more limitations, an element defined by a phrase “include a . . . ” or “comprise a . . . ” does not exclude a case that there are still other identical elements in the process, method, article, or apparatus including the element. In addition, it should be noted that the scope of the method and apparatus in the implementations of the disclosure is not limited to execution of functions in an order shown or discussed, and can further include execution of functions in a substantially simultaneous manner or in a reverse order according to the functions involved. For example, the method described can be executed in an order different from the sequence described, and various steps can be added, omitted, or combined. Moreover, features described with reference to some examples can be combined in other examples.

According to the descriptions in the above implementations, those skilled in the art can clearly understand that the method in the above embodiments can be implemented by means of software and a necessary general hardware platform, and certainly can also be implemented by means of hardware. In many cases, the former is a better implementation. Based on such understanding, the technical solutions of the disclosure in essence or the part contributing to the prior art can be presented in a form of a computer software product. The computer software product is stored in one storage medium (for example, an ROM/RAM, a magnetic disk, and an optical disk) including several instructions to enable one terminal (for example, a mobile phone, a computer, a server, an air conditioner, a network device, etc.) to execute the method in each embodiment of the disclosure.

The embodiments of the disclosure are described above with reference to the accompanying drawings, but the disclosure is not limited to the above particular implementations. The above particular embodiments are merely illustrative rather than restrictive. Inspired by the disclosure, those of ordinary skill in the art can still make multiple forms without departing from the essence of the disclosure and the scope of protection of the claims, and these forms fall within protection of the disclosure.

What is claimed is:

1. A method for transmitting information, comprising:
determining, by a terminal, K groups of second channel information from first channel information based on first information, wherein the first information comprises grouping information of K groups of channel state information-reference signal (CSI-RS) transmission ports, the K groups of second channel information corresponds one-to-one to the K groups of CSI-RS transmission ports, each of the K groups of CSI-RS transmission ports comprises at least one CSI-RS transmission port, and K is an integer greater than or equal to 1;
performing, by the terminal based on first AI network models corresponding to M groups of second channel information respectively, first processing on the M groups of second channel information, and obtaining M pieces of channel feature information, wherein the K groups of second channel information comprises the M groups of second channel information; and
transmitting, by the terminal, second information to a network side device, wherein the second information comprises the M pieces of channel feature information.

2. The method according to claim 1, wherein the first information comprises at least one of the following:
a value of K;
a number of CSI-RS transmission ports in each group of CSI-RS transmission ports; or
identifiers of the CSI-RS transmission ports in each group of CSI-RS transmission ports.

3. The method according to claim 1, wherein CSI-RS transmission ports located in a same group satisfy at least one of the following:
polarization directions are the same;
corresponding transmission antennas are located in a same row;
corresponding transmission antennas are located in a same column;
time-domain resources are the same;
frequency-domain resources are the same;
code division multiple (CDM) manners are the same; or
N CSI-RS transmission ports continuously arranged in all CSI-RS transmission ports for the first channel information are encompassed, wherein N is an integer greater than or equal to 1.

4. The method according to claim 1, wherein the first channel information comprises at least one of the following:
an original channel matrix or vector;
a precoding matrix or vector;
a preprocessed channel matrix or vector; or
a preprocessed precoding matrix or vector.

5. The method according to claim 4, wherein one group of second channel information comprises at least one of the following:
an original channel matrix corresponding to one group of CSI-RS transmission ports, wherein the one group of CSI-RS transmission ports correspond to the one group of second channel information;
a matrix, formed by elements corresponding to the one group of CSI-RS transmission ports, in a first precoding matrix, wherein the first precoding matrix is a precoding matrix of the first channel information; or
a second precoding matrix, wherein the second precoding matrix is a precoding matrix of the one group of second channel information.

6. The method according to claim 1, further comprising:
determining, by the terminal, the first information based on the first AI network model possessed; and
transmitting, by the terminal, first indication information to the network side device, wherein the first indication information indicates the first information.

7. The method according to claim 1, wherein before the determining, by a terminal, K groups of second channel information from first channel information based on first information, the method further comprises:
receiving, by the terminal, third information from the network side device; wherein
the third information indicates or configures the first information; or the third information indicates a first identifier, the first identifier is associated with the first information, and the terminal acquires a first association relationship between the first information and the first identifier.

8. The method according to claim 1, wherein the performing, by the terminal based on first AI network models corresponding to M groups of second channel information respectively, first processing on the M groups of second channel information, and obtaining M pieces of channel feature information comprises:
performing, by the terminal, target normalization processing on the M groups of second channel information separately, and obtaining M groups of third channel information; and
performing, by the terminal, first processing on the M groups of third channel information based on first AI network models corresponding to the M groups of third channel information respectively, and obtaining the M pieces of channel feature information.

9. The method according to claim 8, further comprising:
transmitting, by the terminal, fourth information to the network side device, wherein the fourth information comprises a phase and/or amplitude relationship between M groups of CSI-RS transmission ports corresponding to the M groups of second channel information.

10. The method according to claim 1, wherein a mapping relationship between the second channel information and the first AI network model satisfies at least one of the following:
the M groups of second channel information corresponds to a same first AI network model;
the network side device indicates the first AI network models corresponding to the M groups of second channel information respectively; or
a number of CSI-RS transmission ports in a group of CSI-RS transmission ports corresponding to target second channel information matches an input dimension of a first AI network model corresponding to the target second channel information, wherein the M groups of second channel information comprises the target second channel information.

11. A method for processing information, comprising:
receiving, by a network side device, second information from a terminal, wherein the second information comprises M pieces of channel feature information, and the M pieces of channel feature information is channel feature information obtained by performing, based on first AI network models corresponding to M groups of second channel information respectively, first processing on the M groups of second channel information;
determining, by the network side device, second AI network models corresponding to the M pieces of channel feature information based on first information respectively, wherein the first information comprises grouping information of K groups of channel state information-reference signal (CSI-RS) transmission ports, K groups of second channel information corresponds one-to-one to the K groups of CSI-RS transmission ports, each of the K groups of CSI-RS transmission ports comprises at least one CSI-RS transmission port, the K groups of second channel information comprises the M groups of second channel information, and K and M are integers greater than or equal to 1; and
performing, by the network side device, second processing on the M pieces of channel feature information based on the second AI network models corresponding to the M pieces of channel feature information respectively, and obtaining the M groups of second channel information.

12. The method according to claim 11, wherein the first information comprises at least one of the following:
a value of K;
a number of CSI-RS transmission ports in each group of CSI-RS transmission ports; or
identifiers of the CSI-RS transmission ports in each group of CSI-RS transmission ports.

13. The method according to claim 11, wherein CSI-RS transmission ports located in a same group satisfy at least one of the following:
polarization directions are the same;
corresponding transmission antennas are located in a same row;
corresponding transmission antennas are located in a same column;
time-domain resources are the same;
frequency-domain resources are the same;
code division multiple (CDM) manners are the same; or
N CSI-RS transmission ports continuously arranged in CSI-RS transmission ports for first channel information are encompassed, wherein N is an integer greater than or equal to 1, and the first channel information is channel information of all CSI-RS transmission ports of channels corresponding to the M groups of second channel information.

14. The method according to claim 13, wherein the first channel information comprises at least one of the following:
an original channel matrix or vector;
a precoding matrix or vector;
a preprocessed channel matrix or vector; or
a preprocessed precoding matrix or vector.

15. The method according to claim 14, wherein one group of second channel information comprises at least one of the following:
an original channel matrix corresponding to one group of CSI-RS transmission ports, wherein the one group of CSI-RS transmission ports correspond to the one group of second channel information;
a matrix, formed by elements corresponding to the one group of CSI-RS transmission ports, in a first precoding matrix, wherein the first precoding matrix is a precoding matrix of the first channel information; or
a second precoding matrix, wherein the second precoding matrix is a precoding matrix of the one group of second channel information.

16. The method according to claim 11, wherein before the determining, by the network side device, second AI network models corresponding to the M pieces of channel feature information based on first information respectively, the method further comprises:
receiving, by the network side device, first indication information from the terminal, wherein the first indication information indicates the first information.

17. The method according to claim 11, wherein before the receiving, by a network side device, second information from a terminal, the method further comprises:
transmitting, by the network side device, third information to the terminal; wherein
the third information indicates or configures the first information; or the third information indicates a first identifier, the first identifier is associated with the first information, and the terminal acquires a first association relationship between the first information and the first identifier.

18. The method according to claim 11, wherein the M pieces of channel feature information is channel feature information obtained by performing, based on first AI network models corresponding to M groups of third channel information, first processing on the M groups of third channel information, and the M groups of third channel information is channel information obtained by performing target normalization processing on the M groups of second channel information.

19. The method according to claim 18, wherein the performing, by the network side device, second processing on the M pieces of channel feature information based on the second AI network models corresponding to the M pieces of channel feature information respectively, and obtaining the M groups of second channel information comprises:
receiving, by the network side device, fourth information from the terminal, wherein the fourth information comprises a phase and/or amplitude relationship between M groups of CSI-RS transmission ports corresponding to the M groups of second channel information;
performing, by the network side device, the second processing on the M pieces of channel feature information based on the second AI network models corresponding to the M pieces of channel feature information respectively, and obtaining the M groups of third channel information; and
processing, by the network side device, the M groups of third channel information into the M groups of second channel information based on the fourth information.

20. The method according to claim 11, wherein a mapping relationship between the second channel information and the first AI network model satisfies at least one of the following:
the M groups of second channel information corresponds to a same first AI network model;
the network side device indicates the first AI network models corresponding to the M groups of second channel information respectively; or
a number of CSI-RS transmission ports in a group of CSI-RS transmission ports corresponding to target second channel information matches an input dimension of a first AI network model corresponding to the target second channel information, wherein the M groups of second channel information comprises the target second channel information.
